(19) United States
(12) Patent Application Publication
(10) Pub. No.: US 2014/0337319 A1
(43) Pub. Date: Nov. 13, 2014

(54) SMART PHONE APPLICATION FOR RETRIEVING AND DISPLAYING VEHICLE HISTORY REPORT INFORMATION

(71) Applicant: INNOVA ELECTRONICS, INC., Irvine, CA (US)

(72) Inventor: Ieon C. Chen, Laguna Hills, CA (US)

(73) Assignee: Innova Electronics, Inc., Irvine, CA (US)

(21) Appl. No.: 13/892,839

(22) Filed: May 13, 2013

(51) Int. Cl. G06F 17/30

(52) U.S. Cl. CPC G06F 17/30554
USPC 707/722

(57) ABSTRACT

A system and method for utilizing a hand held electronic device, such as a smart phone to retrieve and display information related to the vehicle history of a vehicle. In particular, the smart phone may be used to take a picture of the vehicle's vehicle identification number (VIN) and upload the VIN to a remote vehicle history database which matches the VIN with stored vehicle history information. The matched vehicle history information is then analyzed to determine a vehicle history status and a corresponding status indicator is illuminated on the smart phone. The indicator may be red, yellow, green to indicate undesirable, cautionary, and clean vehicle history, respectively.

### CROSS-REFERENCE TO RELATED APPLICATIONS

Not Applicable.

### STATEMENT RE: FEDERALLY SPONSORED RESEARCH/DEVELOPMENT

Not Applicable

### BACKGROUND OF THE INVENTION

1. Technical Field of the Invention

The present invention relates generally to using a smart phone to convey vehicle information to a user, and more specifically, to a smart phone application for generating a vehicle history status indicator on the smart phone.

2. Description of the Related Art

Automobiles may be sold as new or used. If new, then purchasers are generally not concerned about wear and tear of the vehicle or broken components because new vehicles are tested at the factory. However, after the new vehicle has been purchased by a buyer and driven for a certain amount of time and mileage, various components of the vehicle may develop wear and tear thereby degrading the performance and reliability of the vehicle. Once the vehicle has been driven, purchasers become concerned that the vehicle may contain hidden defects which may not be readily noticeable.

Another concern associated with purchasing a used vehicle is that the used vehicle may be stolen or may be tampered with to hide negative information associated with the vehicle. For instance, some sellers may tamper with the odometer to decrease the mileage of the vehicle, which in turn allows the seller to ask for a higher selling price.

The prior art has addressed the above-mentioned concerns of buyers through means which are generally expensive. For example, the buyer may have an automobile mechanic inspect the major and minor components of the vehicle to be purchased, which may require repair upon purchase of the vehicle. Furthermore, the inspection may also entail confirming that the odometer reading is accurate. However, an inspection of the vehicle by the mechanic may be difficult to schedule and too expensive in view of the overall cost of the vehicle. Accordingly, except for highly priced vehicles, a mechanic typically does not pre-inspect vehicles for buyers prior to purchase of the vehicle.

Another method by which the buyer may address the concerns regarding the vehicle is to access public records obtained from the Department of Motor Vehicles (DMV). In particular, the public records of the DMV may contain information such as the year, make and model of the vehicle, the number of previous owners, or the like. This information is fairly inexpensive to obtain; however, gathering such information may be an extremely tedious and time consuming process.

Recognizing the deficiencies associated with the above-described methods of obtaining vehicle information, various companies offer vehicle history reports which include vehicle history information for a particular vehicle. Most vehicle history reports include detailed information about the vehicle, such as the number of previous owners, whether the vehicle has been in an accident, and information related to the vehicle title. In general, the vehicle history report may be accessible from a website and may be generated solely from the vehicle identification number (VIN) of the vehicle. The vehicle history reports tend to provide a wealth of information, which may be difficult to parse through for the average consumer lacking automotive expertise. Furthermore, in view of the recent proliferation of smart phones and tablet computers, many individuals may desire to read the vehicle history report on their smart phone or tablet computer; however, such detailed information may be difficult to read on smart phones or a tablet computers, due to the limited display space on such devices.

In view of the foregoing, there is a need in the art for an efficient means by which information related to the vehicle history status may be displayed on a smart phone or similar handheld electronic device.

### BRIEF SUMMARY OF THE INVENTION

The present invention specifically addresses and alleviates the above-identified deficiencies in the art. There is provided a system and method for utilizing a hand held electronic device, such as a smart phone to retrieve and display information related to the vehicle history of a vehicle. In particular, the smart phone may be used to take a picture of the vehicle's vehicle identification number (VIN) and upload the VIN to a remote vehicle history database which matches the VIN with stored vehicle history information. The matched vehicle history information is then analyzed to determine a vehicle history status and a corresponding status indicator is illuminated on the smart phone. The indicator may be red, yellow, green to indicate undesirable, cautionary, and clean vehicle history, respectively. The indicator may be easily displayed on a smart phone or other hand held electronic device with limited display capabilities, and can convey the overall grade of the vehicle history.

According to one embodiment, there is provided a system for use with a smart phone, wherein the system includes a remote vehicle history database having vehicle history information matched with vehicle identification information. The vehicle history database is configured to generate a vehicle history status signal based on an analysis of vehicle history information associated with specific vehicle identification information, wherein the vehicle history status signal is representative of a clean/inconclusive/undesirable vehicle history. The system further includes a computer readable medium downloadable onto the smart phone for configuring the smart phone to transmit a vehicle identification signal including vehicle identification information to the remote vehicle history database; receive the vehicle history status signal from the remote database; and generate a visual output signal on the smart phone, wherein the visual output signal being representative of the received vehicle history status signal.

The computer readable medium may be able to configure the smart phone to perform the receiving and generating steps independent of a user navigating a user interface or independent of user input.

The vehicle identification information may be derived from a vehicle identification number (VIN) associated with a vehicle under consideration, wherein the computer readable medium further configures the smart phone to derive the vehicle identification information from the VIN associated with the vehicle under consideration. The VIN associated with the vehicle under consideration may be derived by the smart phone from a photograph taken by the smart phone or from a bar code scanned by the smart phone.

The vehicle identification information may be derived from a license plate associated with a vehicle under consideration, wherein the computer readable medium further configures the smart phone to derive the vehicle identification information from the license plate associated with the vehicle under consideration. The license plate associated with the vehicle under consideration may be obtained from a photograph taken by the smart phone.

The vehicle identification information may be derived from a VIN associated with a vehicle under consideration, and the computer readable medium may further configure the smart phone to communicate VIN information associated with the vehicle under consideration in the vehicle identification signal. The remote vehicle history database may be configured to derive the vehicle identification information from the VIN information in the vehicle identification signal.

The vehicle identification information may be derived from a license plate associated with a vehicle under consideration and the computer readable medium may further configure the smart phone to communicate license plate information associated with the vehicle under consideration in the vehicle identification signal. The remote vehicle history database may be configured to derive the vehicle identification information from the license plate information in the vehicle identification signal.

The remote vehicle history database may be configured to include vehicle history information in the vehicle history status signal. The computer readable medium may further configure the smart phone to display the vehicle history information received in the vehicle history status signal.

An inconclusive vehicle history status may be determined when at least one of the following conditions is included in the vehicle history information: an odometer-related condition, reported damage, airbag deployed, manufacturer recall and warranty voided. An undesirable vehicle history status may be determined when the vehicle history information includes a branded title designation. A clean vehicle history status may be determined when the vehicle history information does not include any of the conditions associated with an inconclusive vehicle history status or an undesirable vehicle history status.

According to another aspect of the present invention, there is provided system for use with a smart phone, wherein the system includes a remote vehicle history database having vehicle history information matched with vehicle identification information, the vehicle history database being configured to generate a signal including the vehicle history information associated with specific vehicle identification information. The system further includes a computer readable medium downloadable onto the smart phone for configuring the smart phone to transmit a vehicle identification signal including vehicle identification information to the remote vehicle history database; receive the signal including the vehicle history information from the remote database; analyze the vehicle history information to determine a clean/inconclusive/undesirable vehicle history status; and generate a visual output signal on the smart phone, the visual output signal being representative of the vehicle history status.

According to yet another aspect of the present invention, there is provided a method of utilizing a smart phone to interface with a remote vehicle history database for displaying vehicle history information related to a vehicle under consideration, wherein the method comprises the steps of: transmitting a vehicle identification signal from the smart phone to the remote vehicle history database, the vehicle identification signal including vehicle identification information; receiving the vehicle history status signal at the smart phone from the remote database; and generating a visual output signal on the smart phone, the visual output signal being representative of the received vehicle history status signal.

The present invention is best understood by reference to the following detailed description when read in conjunction with the accompanying drawings.

### BRIEF DESCRIPTION OF THE DRAWINGS

These as well as other features of the present invention will become more apparent upon reference to the drawings wherein:

FIG. 1 is a schematic view of one embodiment of a system for generating a vehicle history indication signal on a smart phone;

FIG. 2 is a schematic view of one embodiment of a smart phone used for generating the vehicle history indication signal; and

FIG. 3 is an exemplary flow chart for determining a vehicle history status and generating the vehicle history indication signal.

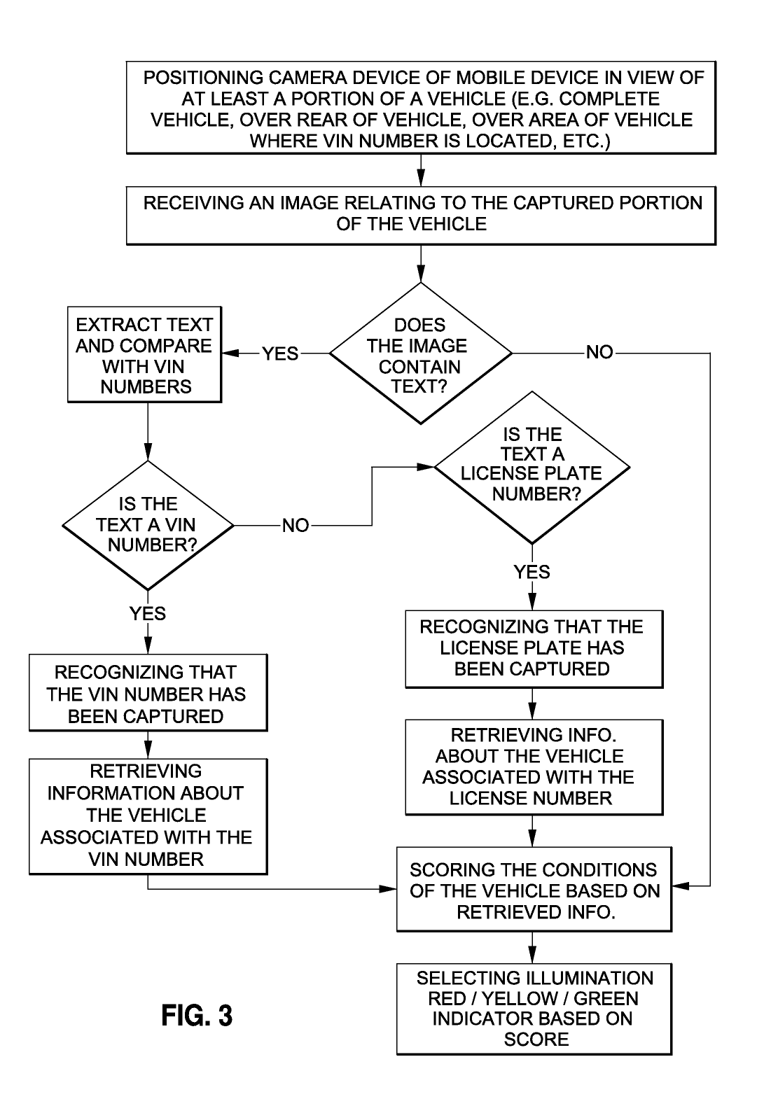

Common reference numerals are used throughout the drawings and detailed description to indicate like elements.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Referring now to the drawings, wherein the showings are for the purposes of illustrating a preferred embodiment of the present invention only, and are not for the purposes of limiting the same, there is depicted a vehicle history indication system 10 specifically adapted to utilize the capabilities of a smart phone 12 for retrieving, communicating and displaying vehicle information. In particular, the smart phone 12 is used to acquire vehicle identification information, i.e., a vehicle identification number (VIN) 13, or license plate information 15, and communicate the vehicle identification information to a remote vehicle history database 14. The vehicle history database 14 matches the received vehicle identification information 17 with vehicle history information 19 stored in the database 14. The vehicle history information is analyzed and scored to determine whether the vehicle history is clean/good, bad/undesirable, or cautionary/inconclusive. Once the vehicle history status is determined, an indicator light 16 is illuminated on the smart phone 12 to quickly and easily communicate the vehicle history status to the user. According to one embodiment, a green indicator light illuminates on the smart phone 12 when the vehicle history status is clean/good, a red indicator light illuminates on the smart phone 12 when the vehicle history status is undesirable/bad, and a yellow indicator light illuminates on the smart phone 12 when the vehicle history status is inconclusive/cautionary.

Various aspects of the present invention convert a conventional smart phone 12 into a powerful and easy-to-use resource that provides critical vehicle history information to a user. Along these lines, a user who is shopping for a used car may use the system 10 to obtain a vehicle history status signal for a vehicle under consideration at any time (i.e., before, during or after the inspection of the vehicle). The system 10 additionally allows a user to obtain vehicle history information in remote locations, (i.e., anywhere the smart phone receives a cellular signal, WiFi signal, or other wireless communication signal). The system 10 additionally presents the information to the user in a format that is easy to discern from a handheld smart phone 12. As will be explained in more detail below, the system 10 preferably configures the smart phone 12 to selectively illuminate a red light, yellow light, or green light depending on the vehicle history status.

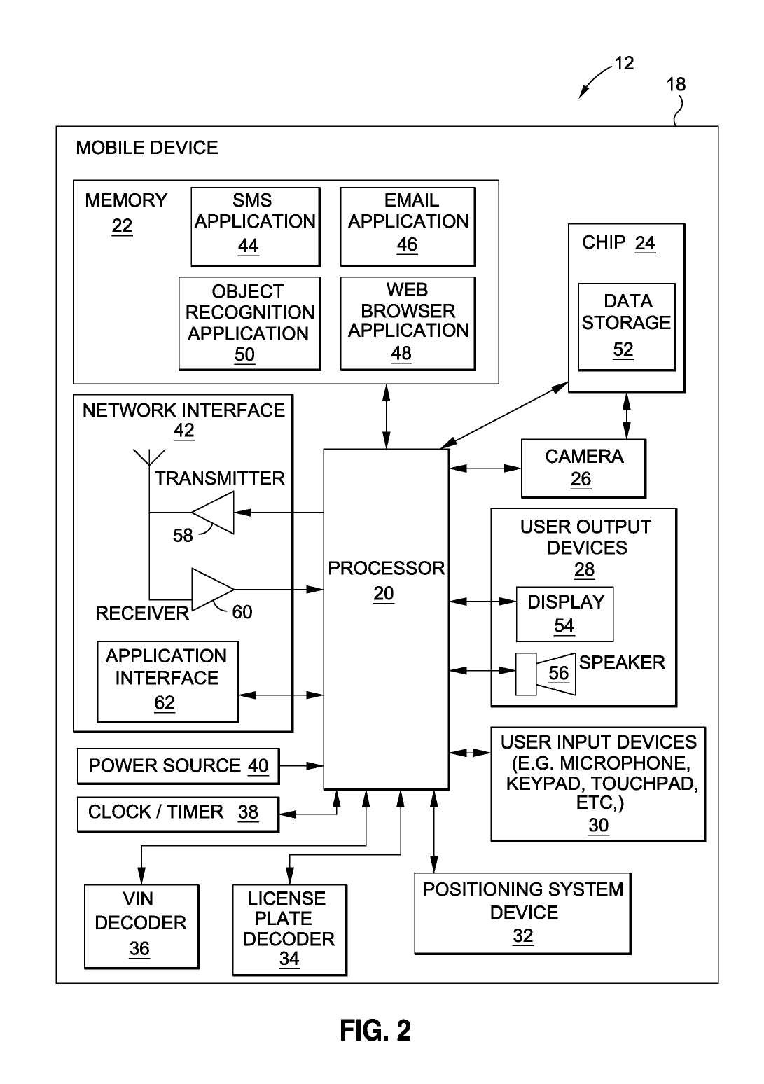

Referring now to FIG. 2, there is shown a schematic diagram of one embodiment of the smart phone 12. The smart phone 12 includes a housing 18 and a processor 20 located within the housing 18 and in operative communication with several smart phone components during operation of the smart phone 12. As will be described in more detail below, the smart phone components generally include a memory 22, a removable chip or data card 24, a camera 26, user output devices 28, user input devices 30, positioning systems device 32, license plate decoder 34, VIN decoder 36, clock/timer 38, power source 40, and network interface 42.

The memory 22 includes a short message service (SMS) application 44 to allow for the exchange of short text messages between the smart phone 12 and a remote device. The memory 22 further includes an email application 46 for allowing the smart phone 12 to receive and send emails. The memory 22 may further include a web browser application 48 for enabling the smart phone 12 to retrieve, present, and access information on the World Wide Web. It is contemplated that the smart phone 12 may employ any one of the SMS application 44, email application 46 or web browser application 48 for communicating with the remote vehicle history database 14.

The memory 22 may additionally include an object recognition application 50 to allow the smart phone 12 to optically recognize characters, symbols, digits, or other indicia located in a photograph, digital document, or other file accessible by the smart phone 12. The object recognition application 50 may be particularly useful in extracting VIN information or license plate information from a photograph taking by the smart phone 12, as will be described in more detailed below.

The chip/data card 24 includes data storage 52 and may be removably insertable into a slot formed within the housing 18 of the smart phone 12. The data storage 52 is accessible by the processor 20 when the chip 24 is inserted in the smart phone 12, and may include executable instructions, databases, or additional storage space which may be needed during operation of the vehicle history indication system 10. For instance, in one embodiment which will be described in more detail below, the data storage 52 may include a VIN database, or a license plate database which is used to decode the vehicle identification information associated with the vehicle under consideration.

The camera 26 may be a conventional smart phone camera mounted on the smart phone 12 and operative to capture images for display and/or storage on the smart phone 12. The camera 26 is used to capture an image of the VIN or license plate associated with the vehicle under consideration.

User output devices 28 include a display 54 and a speaker 56 for visually or audibly outputting information to the user. The user input devices 30 may include a microphone, a key pad, a touch pad, or other input devices integral to the smart phone 12 or externally connectable to the smart phone 12.

Positioning device system 32 may employ conventional Global Positioning System (GPS) technology to provide position information during use of the smart phone 12. The position information may be useful for providing a listing of nearby mechanics, repair facilities, etc.

License plate decoder 34 and VIN decoder 36 are used to decode a license plate or VIN, respectively, into the year, make, model, and/or engine type of the vehicle under consideration. In this regard, the year, make, model, and/or engine type may be derived solely from license plate, or alternatively, solely from the VIN.

Clock/Timer 38 is a conventional smart phone clock/timer and power source 40 is preferably a rechargeable power source, i.e., a battery to power the various smart phone components, or other components connected to the smart phone 12.

Network interface 42 includes transmitter 58, receiver 60, and application interface 62 which is in communication with the transmitter 58, receiver 60, and processor 20.

Although the exemplary embodiment shows the system 10 adapted for use with a smart phone 12, it is also contemplated that other portable hand held electronic communication devices may also be employed. Along these lines, the system 10 may also be used with tablet computers, personal digital assistants (PDAs), or other handheld electronic communication devices known by those skilled in the art.

According to one implementation of the present invention, there is included a computer readable medium downloadable onto the smart phone 12, i.e., a smart phone application (“app.”), for configuring the smart phone 12 to communicate with the remote vehicle history database 14 for determining a vehicle history status and for selectively illuminating the appropriate indicator 16 associated with the determined vehicle history status. The smart phone 12 communicates a signal including vehicle identification information to the vehicle history database 14, and the vehicle history database 14 matches the vehicle identification information with stored vehicle history information to identify vehicle history information associated with the vehicle under consideration. The vehicle history information is analyzed to determine whether the vehicle history is clean, bad/undesirable, or inconclusive/cautionary. A signal related to the vehicle history information is communicated from the remote database to the smart phone 12, and the smart phone 12 illuminates the appropriate indicator 16 associated with the determined vehicle history status.

As will be set forth in more detail below, it is contemplated that the present invention may be implemented in several different embodiments, wherein the processing capabilities at the smart phone level and the remote database level may vary from one embodiment to the next. Furthermore, the content of the signals communicated between the smart phone and the remote database(s) may also vary in different embodiments.

The smart phone 12 includes a built-in camera 26 capable of capturing an image of a vehicle identifying portion of a vehicle under consideration. The vehicle identifying portion of the vehicle may include a listing of the VIN 13 (which is typically located on the dashboard under the windshield, at the front of the engine block, at the front of the car frame, in a rear wheel well, inside the driver-side door jamb or underneath the spare tire) or the license plate 15.

According to one embodiment, the smart phone 12 performs minimal processing and analysis in relation to the image, and simply communicates the image to the remote database 14 for further analysis. In this embodiment, the vehicle identification signal communicated from the smart phone 12 to the remote database 14 is the digital image file captured by the smart phone 12.

In another embodiment, the smart phone 12 may utilize object recognition application 50 located on the smart phone 12 to analyze the image and determine the individual characters of the VIN or license plate. Furthermore, the object recognition application 50 may also be able to determine the state associated with the license plate. Due to the decoding performed by the object recognition application 50, the vehicle identification signal communicated to the remote database 14 from the smart phone 12 may be a text file of the VIN characters or license plate information (i.e., license plate characters and state identification). There may be certain advantages associated with transmitting a small text file from the smart phone 12, rather than the digital image file discussed above. In most cases, the text file is smaller than the digital image file, and therefore, the transmission time will typically be shorter, and the amount of data transmitted from the smart phone 12 will typically be less, which will result in reduced data charges.

It is also contemplated that the smart phone 12 may be capable of scanning a bar code 25 located on the vehicle, wherein the bar code 25 may be decoded to determine the VIN or another identifiable aspect of the vehicle. The vehicle identification signal may include information derived from the scanned information.

The remote vehicle history database 14 is configured to receive the vehicle identification signal from the smart phone 12 to determine the vehicle history status of the vehicle. The vehicle history database 14 includes vehicle history information 19 organized by vehicle identification information 17, and thus, once the vehicle identification information 17 is determined, the vehicle history information 19 can be identified. The vehicle history information 19 for a particular vehicle may include information related to the vehicle title (i.e., salvaged title, junked title, rebuilt, fire damage, other damage), vehicle registration (i.e., state of registration), odometer readings, lemon history, accident history, frame/structural damage information, accident indicators (i.e., airbag deployment), service and repair information, vehicle usage (i.e., taxi, rental, lease, etc.), auction history, emissions information, warranty information, and recall information.

According to one embodiment, the vehicle history database 14 is configured to receive the digital image file from the smart phone 12 and derive the vehicle identification information 17 from the digital image. In this regard, the vehicle history database may include an optical character recognition module 27 capable of determining the VIN or license plate information from the image received from the smart phone 12. Once the VIN or license plate information (i.e., the vehicle identification information) is determined, the vehicle history database 14 identifies the vehicle history information 19 associated with the determined vehicle identification information 17.

In another embodiment, the vehicle history database 14 may receive a text file from the smart phone 12, wherein the text file includes the vehicle identification information 17 of the vehicle under consideration. The vehicle history database 14 is capable of matching the vehicle identification information 17 communicated in the text file and matching the vehicle identification information 17 with the corresponding vehicle history information 19.

The vehicle history database 14 may also be configured to receive a vehicle identification signal including data obtained from scanning a barcode 25 on the vehicle. The vehicle history database 14 may be able to extract the vehicle identification information from the scan data and match the vehicle identification information 17 with the corresponding vehicle history information 19.

Once the vehicle history database 14 identifies the vehicle history information 19, the vehicle history status is determined by analyzing the identified vehicle history information 19. The analysis generally includes reviewing the vehicle history information 19 to determine whether, on balance, the overall vehicle history is clean/good, bad/undesirable, or inconclusive/cautionary. The analysis may be automated, wherein the vehicle history information is analyzed according to an algorithm to determine the overall vehicle history status. A bad/undesirable vehicle history status may be indicative of at least one bad/undesirable condition being present in the vehicle history information, while an inconclusive/cautionary vehicle history status may be indicative of at least one inconclusive/cautionary condition being present in the vehicle history information and the absence of a bad/undesirable condition. A clean/good vehicle history status may be indicative that the vehicle history information does not include any bad/undesirable conditions or inconclusive/cautionary conditions.

In one embodiment, bad/undesirable conditions may include a negative title “brand,” such as salvage or junk, an indication that the vehicle is a total loss, an accident/damage indicative of fire damage, or an indication that the vehicle has been stolen. Exemplary inconclusive/cautionary conditions may include an indication that the airbag deployed, reported damage, odometer issues (i.e., rollback, rollover, inconsistencies, etc.), accident damage, manufacturer recall, or expired/voided warranty. A clean/good vehicle history status would indicate that none of the aforementioned conditions are present in the vehicle history information.

Those skilled in the art will appreciate that the bad/undesirable conditions and inconclusive/cautionary conditions may vary in different implementations of the present invention. For instance, in one embodiment, an indication of an odometer rollback may be classified as an inconclusive/cautionary condition, while in another embodiment, such an indication may be classified as a bad/undesirable condition.

Although the analysis of the vehicle history information may be automated, it is also contemplated that in other embodiments, the vehicle history information may be reviewed by an automotive professional to determine the vehicle history status.

The location of the analysis may vary from one embodiment to the next. In one embodiment, the vehicle history information is analyzed at a remote location (i.e., at the vehicle history database 14) to determine the vehicle history status, and thus, the database 14 may include or have access to the software/algorithms necessary to analyze the vehicle history information. If the vehicle history information is analyzed at the database 14, a vehicle history status signal associated with the determined vehicle history status is communicated from the database 14 to the smart phone 12. In other embodiments, the vehicle history information is communicated to the smart phone 12 for analysis on the smart phone 12. In this regard, it is contemplated that the smart phone 12 may include software/algorithms for analyzing the vehicle history information. The software/algorithms may be included as part of the downloadable computer readable medium (i.e., smart phone app) that may be downloaded onto the smart phone.

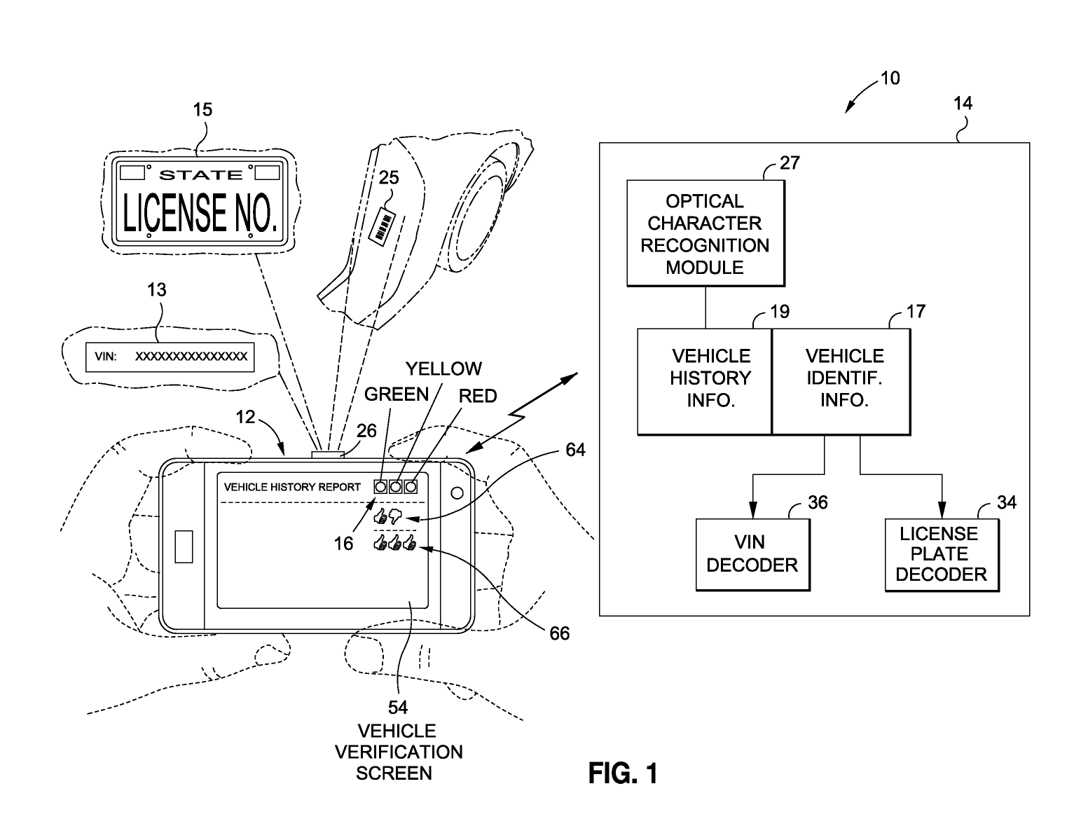

After the vehicle history status is determined, the smart phone 12 generates a visual output signal 16 on the smart phone 12 representative of the vehicle history status. According to one embodiment, the visual outputs representative of clean/inconclusive/undesirable vehicle history include a green light, a yellow light, and a red light, respectively, however, other lights or indication signals may be used without departing from the spirit and scope of the present invention. For instance, FIG. 1 additionally shows positive icons (i.e., “thumbs up”) and/or negative icons (i.e., “thumbs down”) which may be used/illuminated to indicate the status of the vehicle history. Indicator 64 shows a positive “thumbs up” icon and a negative “thumbs down” icon for visually representing the vehicle history status. When the vehicle history is positive, the “thumbs up” icon is illuminated and when the vehicle history is negative, the “thumbs down” icon is illuminated. Another embodiment is shown as indicator 66, which includes a plurality of positive “thumbs up” icons. The number of “thumbs up” icons illuminated on the smart phone is representative of the strength or desirability vehicle history status. For instance, if all three of the “thumbs up” icons are illuminated, then the vehicle history status may be highly desirable. In contrast, if none of the “thumbs up” icons are illuminated, then the vehicle history status may be highly undesirable. If only one or a few “thumbs up” icons are illuminated, the vehicle history status may be inconclusive or cautionary.

In addition to visual indicators, it is contemplated that audible alert signals may also be used to indicate the vehicle history status.

In a preferred implementation of the present invention, the process of illuminating the appropriate indicator light 16 is a substantially autonomous process and requires very little, if any, input from a user. In this regard, the user input may be limited to opening/initiating the program on the smart phone 12, and taking the picture/capturing the vehicle identification information from the vehicle. Once the picture is taken, the smart phone 12 may automatically communicate with the remote database 14 to transfer the necessary information for determining the vehicle history status and generating the indication signal. Thus, the user is not required to navigate a user interface or provide input during the automated portion of the process.

The indicator signal 16 preferably includes a small light that is easily illuminated on the smart phone display. According to one implementation of the present invention, the smart phone display may also display a portion or the entirety of the vehicle history report. For instance, the smart phone 12 may display the conditions which triggered the vehicle history status (i.e., the bad or cautionary conditions).

Additional modifications and improvements of the present invention may also be apparent to those of ordinary skill in the art. Thus, the particular combination of components and steps described and illustrated herein is intended to represent only certain embodiments of the present invention, and is not intended to serve as limitations of alternative devices and methods within the spirit and scope of the invention.

What is claimed is:

1. A system for use with a smart phone, the system comprising:
a remote vehicle history database having vehicle history information matched with vehicle identification information, the vehicle history database being configured to generate a vehicle history status signal based on an analysis of vehicle history information associated with specific vehicle identification information, the vehicle history status signal being representative of a clean/inconclusive/undesirable vehicle history; and
a computer readable medium downloadable onto the smart phone for configuring the smart phone to:
transmit a vehicle identification signal including vehicle identification information to the remote vehicle history database;
receive the vehicle history status signal from the remote database; and
generate a visual output signal on the smart phone, the visual output signal being representative of the received vehicle history status signal.

2. The system recited in claim 1, wherein the receiving and generating steps are performed independent of a user navigating a user interface.

3. The system recited in claim 1, wherein the receiving and generating steps are performed independent of user input.

4. The system recited in claim 1, wherein the visual output signals representative of clean/inconclusive/undesirable vehicle history include a green light, a yellow light, and a red light, respectively.

5. The system recited in claim 1, wherein the visual output signal representative of clean vehicle history includes a positive icon, and the visual output signal representative of an undesirable vehicle history includes a negative icon.

6. The system recited in claim 1, wherein the visual output signal representative of an undesirable vehicle history includes a first number of icons and the visual output signal representative of a clean vehicle history includes a second number of icons greater than the first number of icons.

7. The system recited in claim 1, wherein the vehicle identification information is derived from a vehicle identification number (VIN) associated with a vehicle under consideration, the computer readable medium further configuring the smart phone to derive the vehicle identification information from the VIN associated with the vehicle under consideration.

8. The system recited in claim 7, wherein the VIN associated with the vehicle under consideration is derived by the smart phone from a photograph taken by the smart phone.

9. The system recited in claim 7, wherein the VIN associated with the vehicle under consideration is derived by the smart phone from a bar code scanned by the smart phone.

10. The system recited in claim 1, wherein the vehicle identification information is derived from a license plate associated with a vehicle under consideration, the computer readable medium further configuring the smart phone to derive the vehicle identification information from the license plate associated with the vehicle under consideration.

11. The system recited in claim 10, wherein the license plate associated with the vehicle under consideration is obtained from a photograph taken by the smart phone.

12. The system recited in claim 1, wherein:
the vehicle identification information is derived from a vehicle identification number (VIN) associated with a vehicle under consideration;
the computer readable medium further configures the smart phone to communicate VIN information associated with the vehicle under consideration in the vehicle identification signal;
the remote vehicle history database being configured to derive the vehicle identification information from the VIN information in the vehicle identification signal.

13. The system recited in claim 1, wherein:
the vehicle identification information is derived from a license plate associated with a vehicle under consideration;
the computer readable medium further configures the smart phone to communicate license plate information associated with the vehicle under consideration in the vehicle identification signal;
the remote vehicle history database being configured to derive the vehicle identification information from the license plate information in the vehicle identification signal.

14. The system recited in claim 1, wherein:
the remote vehicle history database is configured to include vehicle history information in the vehicle history status signal;
the computer readable medium further configuring the smart phone to display the vehicle history information received in the vehicle history status signal.

15. The system recited in claim 1, wherein:
an inconclusive vehicle history status is determined when at least one of the following conditions is included in the vehicle history information: an odometer-related condition, reported damage, airbag deployed, manufacturer recall and warranty voided;
an undesirable vehicle history status is determined when the vehicle history information includes a branded title designation; and
a clean vehicle history status is determined when the vehicle history information does not include any of the conditions associated with an inconclusive vehicle history status or an undesirable vehicle history status.

16. A system for use with a smart phone, the system comprising:
a remote vehicle history database having vehicle history information matched with vehicle identification information, the vehicle history database being configured to generate a signal including the vehicle history information associated with specific vehicle identification information; and
a computer readable medium downloadable onto the smart phone for configuring the smart phone to:
transmit a vehicle identification signal including vehicle identification information to the remote vehicle history database;
receive the signal including the vehicle history information from the remote database;
analyze the vehicle history information to determine a clean/inconclusive/undesirable vehicle history status; and
generate a visual output signal on the smart phone, the visual output signal being representative of the vehicle history status.

17. The system recited in claim 16, wherein:
an inconclusive vehicle history status is determined when at least one of the following conditions is included in the vehicle history information: an odometer-related condition, reported damage, airbag deployed, manufacturer recall and warranty voided;
an undesirable vehicle history status is determined when the vehicle history information includes a branded title designation; and
a clean vehicle history status is determined when the vehicle history information does not include any of the conditions associated with an inconclusive vehicle history status or an undesirable vehicle history status.

18. The system recited in claim 16, wherein the visual outputs representative of clean/inconclusive/undesirable vehicle history include a green light, a yellow light, and a red light, respectively.

19. The system recited in claim 16, wherein the vehicle identification information is derived from a vehicle identification number (VIN) associated with a vehicle under consideration, the computer readable medium further configuring the smart phone to derive the vehicle identification information from the VIN associated with the vehicle under consideration.

20. The system recited in claim 16, wherein the vehicle identification information is derived from a license plate associated with a vehicle under consideration, the computer readable medium further configuring the smart phone to derive the vehicle identification information from the license plate associated with the vehicle under consideration.

21. The system recited in claim 16, wherein:
the vehicle identification information is derived from a vehicle identification number (VIN) associated with a vehicle under consideration;
the computer readable medium further configures the smart phone to communicate VIN information associated with the vehicle under consideration in the vehicle identification signal;
the remote vehicle history database being configured to derive the vehicle identification information from the VIN information in the vehicle identification signal.

22. The system recited in claim 16, wherein:
the vehicle identification information is derived from a license plate associated with a vehicle under consideration;
the computer readable medium further configures the smart phone to communicate license plate information associated with the vehicle under consideration in the vehicle identification signal;
the remote vehicle history database being configured to derive the vehicle identification information from the license plate information in the vehicle identification signal.

23. A method of utilizing a smart phone to interface with a remote vehicle history database for displaying vehicle history information related to a vehicle under consideration, the remote vehicle history database having vehicle history information matched with vehicle identification information, the vehicle history database being configured to generate a vehicle history status signal based on an analysis of vehicle history information associated with specific vehicle identification information, the vehicle history status signal being representative of a clean/inconclusive/undesirable vehicle history, the method comprising the steps of:
transmitting a vehicle identification signal from the smart phone to the remote vehicle history database, the vehicle identification signal including vehicle identification information;
receiving the vehicle history status signal at the smart phone from the remote database; and
generating a visual output signal on the smart phone, the visual output signal being representative of the received vehicle history status signal.

24. A computer readable medium usable on a smart phone for interfacing the smart phone with a remote vehicle history database having vehicle history information matched with vehicle identification information, the vehicle history database being configured to generate a vehicle history status signal based on an analysis of vehicle history information associated with specific vehicle identification information, the vehicle history status signal being representative of a clean/inconclusive/undesirable vehicle history, the computer readable medium being operative to configure the smart phone to:
transmit a vehicle identification signal including vehicle identification information to the remote vehicle history database;
receive the vehicle history status signal from the remote database; and
generate a visual output signal on the smart phone, the visual output signal being representative of the received vehicle history status signal.
